(19) United States
(12) Patent Application Publication
(10) Pub. No.: US 2025/0100820 A1
(43) Pub. Date: Mar. 27, 2025

(54) LOOSE FILL DELIVERY MACHINE

(71) Applicant: CERTAINTEED LLC, Malvern, PA (US)

(72) Inventors: Bruce A. HARTZELL, Mickleton, NJ (US); Juan C. MIRANDA, Lakeland, FL (US); Alejandro GONZALEZ-ALOM, Winter Haven, FL (US); Jason ST. JOHN, Valrico, FL (US)

(21) Appl. No.: 18/890,064

(22) Filed: Sep. 19, 2024

Related U.S. Application Data
(60) Provisional application No. 63/585,783, filed on Sep. 27, 2023.

(51) Int. Cl. B65G 65/28

(52) U.S. Cl. CPC B65G 65/28; B65G 2814/0302

(57) ABSTRACT

A loose fill insulation delivery machine can include a hopper configured to receive loose fill insulation; a counter configured to determine an amount of loose fill insulation used; and a display system configured to determine service part replacement. A method of determining service part replacement in a loose fill insulation delivery machine can include operations for tracking a run time of the insulation blowing machine; determining service part replacement based on tracked run time; and displaying service part replacement information.

### CROSS-REFERENCE TO RELATED APPLICATION(S)

This Application claims priority under 35 U.S.C. § 119 (c) to U.S. Provisional Patent Application No. 63/585,783, entitled “LOOSE FILL DELIVERY MACHINE,” filed Sep. 27, 2023, by Bruce A. HARTZELL et al., which is assigned to the current assignee hereof and is incorporated herein by reference in its entirety.

### FIELD OF THE DISCLOSURE

The present disclosure generally relates to loose fill insulation installation systems.

### BACKGROUND

Loose fill insulation is packaged in bags and traditionally used in pneumatic devices to install and condition the insulation. The insulation is blown through a hose connected to the pneumatic device. Various issues can arise between placing the bag in the machine and blowing the insulation through the hose connected to the pneumatic device. Issues can range from inaccurate measurement of material usage to blockages or misfiring parts.

There exists a need in the art for improved installation of loose fill insulation, particularly understanding problems that arise. More specifically, there is a need in the art for cost-effective performance within pneumatic and conditioning devices to enhance durability and efficiency of performance.

### SUMMARY

According to one embodiment, a loose fill insulation delivery machine is disclosed. The machine can include a hopper configured to receive loose fill insulation; a counter configured to determine an amount of loose fill insulation used; and a display system configured to determine service part replacement.

According to a further embodiment, a method of determining service part replacement in a loose fill insulation delivery machine is disclosed. Such a method can include: tracking a run time of the insulation blowing machine; determining service part replacement based on tracked run time; and displaying service part replacement information.

According to one embodiment, a loose fill insulation delivery machine is disclosed. The machine can include a hopper configured to receive loose fill insulation; a counter configured to do one or more of the following features: determine an amount of loose fill insulation used, determine service part replacement, receive information from the counter, display troubleshooting instructions after receiving input on where the loose fill insulation delivery machine is non-functional, temporarily disable the loose fill insulation delivery machine, determine an amount of time the loose fill insulation delivery machine is powered on and any combination thereof.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a side view of a loose fill insulation delivery system, according to one embodiment.

FIG. 2 includes an illustration of a front view of a loose fill insulation delivery system, according to one embodiment.

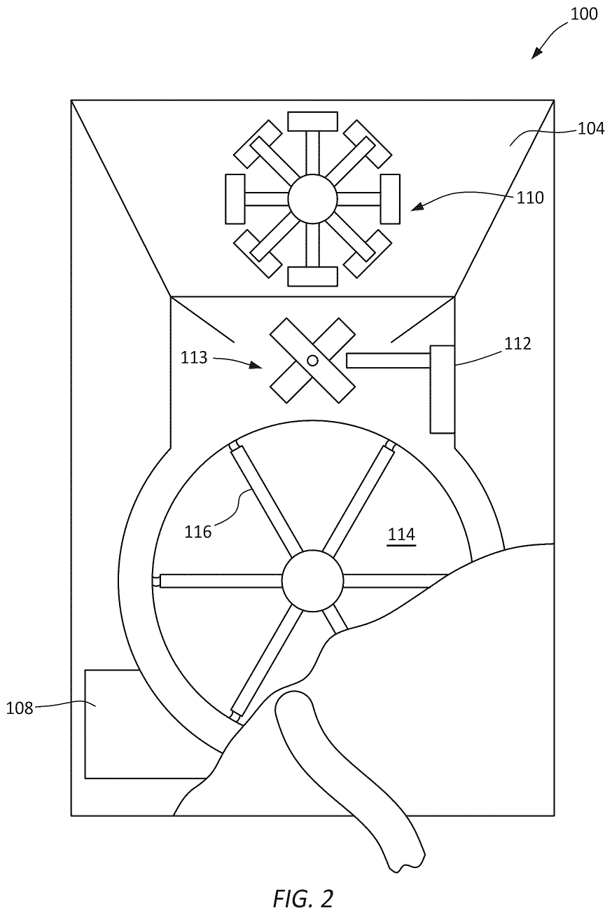

FIG. 3 includes an illustration of an outer view of a loose fill insulation delivery system, according to one embodiment.

FIG. 4 includes an illustration of a module of the display system of the loose fill insulation delivery system of FIG. 1, according to one embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the construction products arts.

Various embodiments of the present disclosure will now be described, by way of example only, with reference to the accompanying drawings.

The present disclosure relates to a loose fill insulation installation and delivery system able to maintain equipment operations at peak performance levels. The loose fill insulation delivery system includes a display and technology package to track and show material usage, machine usage, malfunction identification, and identification of servicing needs to maintain the machine at peak performance not previously seen.

As one of skill in the art will appreciate, there can be varying materials that may be delivered by such a loose fill insulation machine. These materials can include, but are not limited to, fiberglass, stone wool, cellulose, natural fibers, cotton, polymer fibers, plastic fibers, mineral (rock or slag) wool, fireproofing materials, and other granular or fibrous materials.

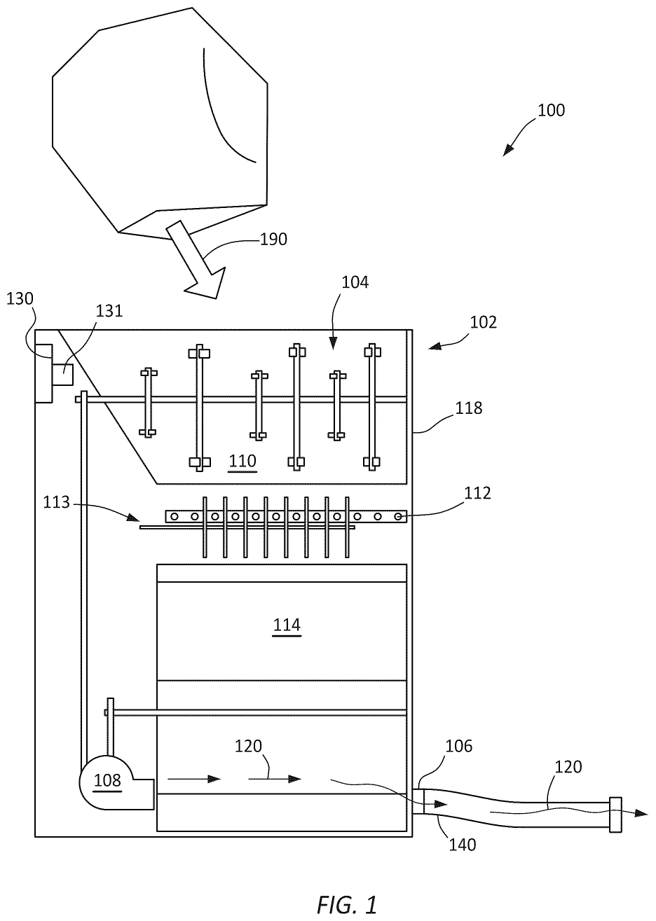

FIG. 1 illustrates a loose fill insulation delivery system 100, according to one embodiment. The loose fill insulation system 100 can include a loose fill insulation blowing machine 102. The loose fill insulation blowing machine 102 can receive packed loose fill insulation 190, condition the insulation 190, and convey the insulation 190 toward the installation site. The loose fill insulation blowing machine can include a housing 118, a hopper 104, a blower 108, an air lock feeder 114, and a display system 130.

The hopper 104 can be configured to receive loose fill insulation 190. In one embodiment, the hopper 104 can have inclined or tapered sides to help direct the insulation 190 towards the air lock feeder 114. In one embodiment, the hopper 104 can have an inlet configured to receive the insulation 190 and an outlet which is in fluid communication with the air lock feeder 114. In one embodiment, the inlet of the hopper 104 can be larger than the outlet of the hopper 104. In one embodiment, the hopper 104 can include an agitator 110 and a shredder box 113. The agitator 110 can be configured to break apart the loose fill insulation 190 within the hopper 104 and the shredder box 113 can further break apart the loose insulation before it enters the air lock feeder 114. The agitator 110 can include one or more paddles or other rotating members that rotate through the hopper and break up the insulation 190. The shredder box 113 can include one or more blades or other rotating members that rotate at the bottom of the hopper 104 to further break apart the loose insulation 190. In one embodiment, the agitator 110 and the shredder box 113 can move the loose fill insulation 190 from the opening of the hopper 104 towards the air lock feeder 114.

The air lock feeder 114 can be disposed downstream of the hopper 104 and can include one or more sealed vanes 116. The one or more sealed vanes 116 can rotate in a drum that in turn transports the insulation 190 from the hopper 104 towards the blower 108 and a flow path 120. The blower 108 along with the air lock feeder 114 can direct the air flow out through an outlet conduit 106 rather than back into the hopper 104. The outlet conduit 106 can extend from the air lock feeder 114. In one embodiment, the outlet conduit 106 can be configured to connect with a loose fill insulation hose 140.

In one embodiment, the blower machine 102 can include a stator bar 112. The stator bar 112 can be disposed between the hopper 104 and the air lock feeder 114, and positioned vertically next to the shredder box 113. The blades of the shredder box 113 can be positioned such that they bypass one of more tines of the stator bar 112, which remain stationary relative to the housing 118. The one or more tines of the stator bar 112 can be used to prevent large masses of insulation from passing into the air lock feeder 114. As the blades of the shredder box 113 pass between adjacent pairs of the tines of the stator bar 112, any larger clumps of loose insulation 109 can be further separated to ensure movement of the loose insulation 190 through the loose fill insulation delivery system 100. In another embodiment, in the place of a stator bar 112 and shredder box 113, a screen or baffle can be used. In yet another embodiment, the stator bar 112 and shredder box 113 can be used in combination with a screen or baffle to prevent large masses of insulation from passing into the air lock feeder 114.

The blower 108 can be in fluid communication with at least a portion of the loose fill insulation 190 received in the air lock feeder 114. In one embodiment, the insulation 190 delivered to the air lock feeder 114 can be directed towards a flow path 120. In one embodiment the blower 108 can force air along the flow path 120 toward an installation site. The air moved by the blower 108 can convey the loose fill insulation along the flow path 120 towards the installation site. The blowing machine 102 can also include the display system 130. While shown in FIG. 1 as within the housing 118 of the blowing machine 102, the display system 130 can be on the outside of the blowing machine 102.

In one embodiment, the display system 130 can be electrically coupled to the blowing machine 102 such that information, instructions, and signals can pass between the blowing machine and the display system. In one embodiment, the display system 130 can be configured to receive information from a counter, determine service part replacement, display troubleshooting instructions, and display part replacement instructions. In one embodiment, the blower machine can include a counter 131 that is in communication with the display system 130.

In operation, loose fill insulation 190 can be placed in the hopper 104. The counter 131 and display system 130 can keep track of the amount of loose fill insulation 190 that is used by the blowing machine 102. In one embodiment, the counter 131 can measure the amount of loose fill insulation used in the blowing machine 102. In one embodiment, the counter 131 can be connected to the stator bar and in operation can keep track of when the stator bar 112 and the shredder box 113 are in use.

In another embodiment, the counter 131 can be connected to a power source to keep track of when the blowing machine 102 is operational. In one embodiment, the counter 131 can keep track of the number of hours the blowing machine 102 is operational. In one embodiment, the counter 131 can detect an addition of weight to the hopper 104. In one embodiment, the counter 131 can detect the passing of material into the hopper 104 space through the blocking of a photocell or similar sensor device.

In one embodiment, the counter 131 can determine amount of material flowing out of the blowing machine 102 by detecting an air flow rate from the blower 108, detecting a density of material passing through the outlet conduit 106 (such as through the blocking of a photocell or similar sensor device monitoring the outlet conduit 106), and keeping track of the amount of time the blowing machine 102 is operating to determine total material flow. In one embodiment, the counter 131 can be manually advanced. In one embodiment, the counter 131 can be automatically advanced in response to an input signal. In one embodiment, the counter 131 can be both manually advanced and automatically advanced.

In one embodiment, the display system 130 can receive inputs and display information represented by these inputs. In one embodiment, the display system 130 can include a logic element that can perform the method described below. The logic for the display system 130 can be in the form of hardware, software, or firmware. In an embodiment, the logic may be stored in a field programmable gate array (FPGA), an application-specific integrated circuit (ASIC), a hard drive, a solid state drive, or another persistent memory. In an embodiment, the display system 130 may include a processor that can execute instructions stored in memory within the display system 130 or received from an external source (e.g., via a communication network).

The display system 130 can be coupled to a router via a control link. The control link can be a wired or wireless connection. In an embodiment, the control link can use a wireless local area network connection operating according to one or more of the standards within the IEEE 802.11 (Wi-Fi) family of standards. In a particular aspect, the wireless connections can operate within the 2.4 GHZ ISM radio band, within the 5.0 GHZ ISM radio band, or a combination thereof. Regardless of the type of control link, the display system 130 can receive power and send signals to the router via the control link. The signals can be used to send operational information about the blowing machine 102 to a remote user, as described below.

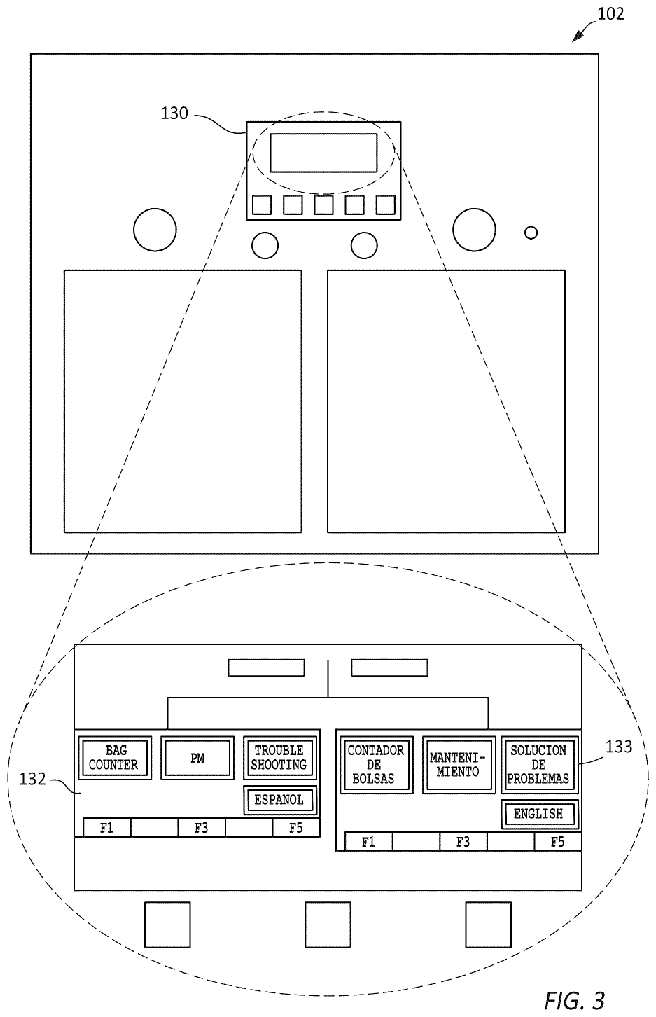

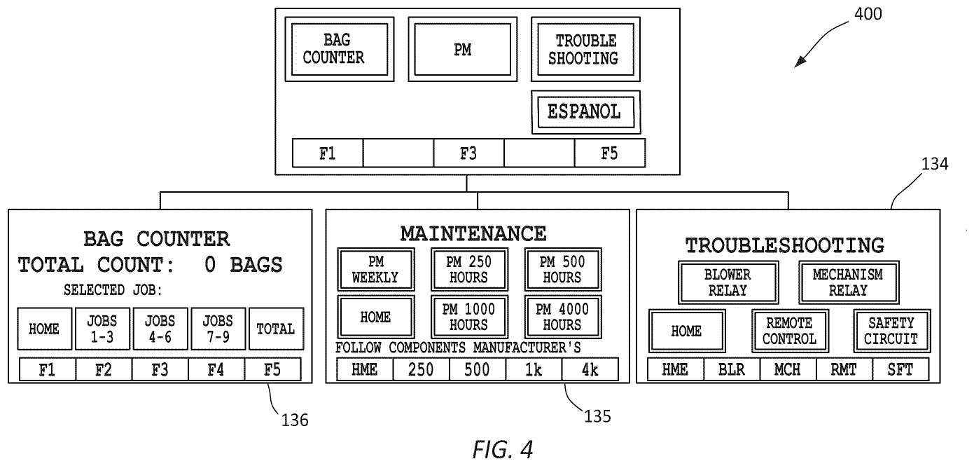

The display system 130 can include a plurality of modules. As seen in FIGS. 3 and 4, the display system 130 can include modules 132, 133, 134, 135, 136. While FIGS. 3 and 4 show exemplary modules, other modules can be displayed. In another embodiment, the display system 130 can include at least 2 modules, such as at least 3 modules, or at least 4 modules, at least 10 modules, or at least 20 modules. In one embodiment, the display module 130 can include at most 50 modules, such as at most 40 modules, or at most 30 modules. Each module can control a different operation. In one embodiment, a user could manually adjust various modules, such as bag count. In one embodiment, the modules can also display the status of the blowing machine 102.

For example, the module can display the number of bags of loose fill insulation used at varying job sites, the number of hours the blowing machine 102 has been operational, the parts that need replacing as part of maintenance, or information regarding how to fix a problem that may have occurred. In one embodiment, the display system 130 can include touch activated buttons for a user to input information.

In operation, the modules of the display system 130 can display one or more status updates about the blowing machine 102. The display system 130 can receive input to change the modules. In one embodiment, the module can display the amount of loose fill insulation 190 used within the blowing machine 102. In one embodiment, another module can display information regarding maintenance of the blowing machine 102. In one embodiment, the display system 130 can keep track of the number of hours the blowing machine is operational, such as via the counter 131.

A logic element in the display system 130 can determine, based on the information received (e.g., from the counter 131), whether maintenance on the blowing machine is needed. If maintenance is needed, the display system 130 can display which part needs to be replaced, oiled, cared for, or changed. In one embodiment, the display system 130 can temporarily disable the blowing machine 102 and prevent the blowing machine 102 from running until the maintenance on the blowing machine 102 is complete.

In one embodiment, the maintenance of the machine can be based on an amount of time the blowing machine 102 has been operational. Maintenance can include weekly tasks to the machine, such as greasing a pillow block bearing, or tasks based on the number of hours the machine is operational, such as after 250 hours changing the seals. The display system 130 can receive inputs from the blowing machine 102 and display those inputs in one or more modules. Maintenance and repair on the blowing machine 102 can be based on the information displayed by the display system 130.

If the loose fill blowing machine 102 stops operating, normally the machine would have to be taken in to be fixed or a technician would be called to fix the machine on-site. A user can use the display system 130 to troubleshoot where a problem with the machine 102 may lie by utilizing the modules 400.

Each of the modules 400 can include a control screen displayable by the display system 130 to provide interaction between a user and the blowing machine 102. For example, the main control screen can have selectable graphic user interface (GUI) buttons (e.g., icons on a touch screen) to select which of the modules 400 the user wishes to access. For example, a GUI button can be a “bag counter” button that causes a control screen for the bag counter module 136 to be displayed. The bag counter control screen can provide additional GUI buttons to return to the main control screen (e.g., “home”), view bag counts from previous jobs (e.g., “jobs 1-3”, “jobs 4-6”, etc.), and view a total amount of material used (e.g., “total”). Additional GUI buttons can be programmable buttons (e.g., “F1-F5”) for further customization of the control screens.

For example, a GUI button can be a “PM” button that causes a control screen for the periodic maintenance module 135 to be displayed. The periodic maintenance control screen can provide additional GUI buttons to return to the main control screen (e.g., “home”) and view various timed maintenance items (e.g., maintenance performed every week “PM weekly”, maintenance performed every 250 hours “PM 250 hours”, etc.).

For example, a GUI button can be a “Trouble Shooting” button that causes a control screen for the trouble shooting module 134 to be displayed. The trouble shooting control screen can provide additional GUI buttons to return to the main control screen (e.g., “home”), test the blower relay “Blower Relay”, test the mechanism relay “Mechanism Relay”, test the remote control “Remote Control”, and test the safety circuit “Safety Circuit”. Each of these operations may provide information to the user to facilitate testing each of these items, and receive feedback from the user to determine the cause of the current problem.

Each of the control screens can also include a GUI button to select which display (and possibly voice command) language is desired. Such as, if the ESPANOL button is selected, then the wording on the control screens can be displayed in Spanish, and any audible instructions from the display system 130 can also be voiced in Spanish. If the ENGLISH button is selected, then the wording on the control screens can be displayed in English, and any audible instructions from the display system 130 can also be voiced in English. This is illustrated in FIG. 3, where the control screen for the module 132 is displaying English, while the control screen for the module 133 can display Spanish.

In one embodiment, module 134 can provide guidance to the user for determining what part of the blowing machine 102 may be causing the problem and may need to be fixed. In one embodiment, the display system 130 can display options on where a user should look for problems.

The display system 130 can receive an input to test various parts of the blowing machine 102. In one embodiment, the blower 108 is tested for functionality. In another embodiment, the safety circuit can be tested for functionality. In another embodiment, the control systems for the blowing machine 102 can be tested for functionality. The display system 130 can display the results of that testing. A user can then take action to fix the blowing machine 102 based on the results output from the display system 130.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Various Embodiments

Embodiment 1. A loose fill insulation delivery machine is disclosed. The machine can include a hopper configured to receive loose fill insulation; a counter configured to determine the amount of loose fill insulation used; and a display system configured to determine service part replacement.

Embodiment 2. The loose fill insulation delivery machine of embodiment 1, where the display system is configured to receive information from the counter.

Embodiment 3. The loose fill insulation delivery machine of embodiment 1, where the display system is configured to determine an amount of loose fill insulation used.

Embodiment 4. The loose fill insulation delivery machine of embodiment 1, where the display system is configured to display troubleshooting instructions after receiving input on where the machine is non-functional.

Embodiment 5. The loose fill insulation delivery machine of embodiment 1, where the display system is configured to receive information from the counter.

Embodiment 6. The loose fill insulation delivery machine of embodiment 1, where the counter is configured to determine an amount of time the loose fill insulation delivery machine is powered on.

Embodiment 7. The loose fill insulation delivery machine of embodiment 1, where the display system can temporarily disable the loose fill insulation delivery machine.

Embodiment 8. The loose fill insulation delivery machine of embodiment 1, where the counter can detect an addition of weight to the hopper.

Embodiment 9. The loose fill insulation delivery machine of embodiment 1, where the counter can detect the passing of material into the hopper through a blocking of a photocell or a sensor device.

Embodiment 10. The loose fill insulation delivery machine of embodiment 1, where the counter can be manually advanced.

Embodiment 11. The loose fill insulation delivery machine of embodiment 1, where the counter can be automatically advanced in response to an input signal.

Embodiment 12. The loose fill insulation delivery machine of embodiment 1, where the counter can be both manually advanced and automatically advanced.

Embodiment 13. A method of determining service part replacement in a loose fill insulation delivery machine, which can include: tracking a run time of the insulation blowing machine; determining service part replacement based on tracked run time; and displaying service part replacement information.

Embodiment 14. The method of determining service part replacement in a loose fill insulation delivery machine of embodiment 13, further can include disabling the loose fill insulation delivery machine until service part replacement is complete.

Embodiment 15. The method of determining service part replacement in a loose fill insulation delivery machine of embodiment 13, further can include tracking a material usage of the insulation blowing machine and determining service part replacement based on the material usage.

Embodiment 16. The method of determining service part replacement in a loose fill insulation delivery machine of embodiment 13, where tracking the run time, determining the service part replacement, and displaying service part replacement information is all done within the loose fill insulation delivery machine.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A loose fill insulation delivery machine comprising:
a hopper configured to receive loose fill insulation;
a counter configured to determine an amount of loose fill insulation used; and
a display system configured to determine service part replacement.

2. The loose fill insulation delivery machine of claim 1, wherein the display system is configured to receive information from the counter.

3. The loose fill insulation delivery machine of claim 1, wherein the display system is configured to determine an amount of loose fill insulation used.

4. The loose fill insulation delivery machine of claim 1, wherein the display system is configured to display troubleshooting instructions after receiving input on where the loose fill insulation delivery machine is non-functional.

5. The loose fill insulation delivery machine of claim 1, where the display system is configured to receive information from the counter.

6. The loose fill insulation delivery machine of claim 1, wherein the counter is configured to determine an amount of time the loose fill insulation delivery machine is powered on.

7. The loose fill insulation delivery machine of claim 1, wherein the display system can temporarily disable the loose fill insulation delivery machine.

8. The loose fill insulation delivery machine of claim 1, where the counter can detect an addition of weight to the hopper.

9. The loose fill insulation delivery machine of claim 1, where the counter can detect passing of material into the hopper through a blocking of a photocell or a sensor device.

10. The loose fill insulation delivery machine of claim 1, where the counter can be manually advanced.

11. The loose fill insulation delivery machine of claim 1, where the counter can be automatically advanced in response to an input signal.

12. The loose fill insulation delivery machine of claim 1, where the counter can be both manually advanced and automatically advanced.

13. A method of determining service part replacement in a loose fill insulation delivery machine, the method comprising:
tracking a run time of the loose fill insulation delivery machine;
determining service part replacement based on tracked run time; and
displaying service part replacement information.

14. The method of claim 13, further comprising disabling the loose fill insulation delivery machine until service part replacement is complete.

15. The method of claim 13, further comprising tracking a material usage of the loose fill insulation delivery machine and determining service part replacement based on the material usage.

16. The method of claim 13, wherein tracking the run time, determining the service part replacement, and displaying service part replacement information is all done within the loose fill insulation delivery machine.
